(19) United States
(12) Patent Application Publication
(10) Pub. No.: US 2010/0011520 A1
(43) Pub. Date: Jan. 21, 2010

(54) Lightweight portable wheelchair ramp

(76) Inventor: Kenan Wollborg, Inkster, MI (US)

Correspondence Address: I. Michael Bak-Boychuk;Attorney at Law, P.O.Box 32501, Long Beach, CA, 90832, US

(21) Appl. No.: 12/454,068

(22) Filed: May 12, 2009

Related U.S. Application Data
(60) Provisional application No. 61/135,092, filed on Jul. 16, 2008.

(51) Int. Cl. B65G 69/28; B29C 65/02

(52) U.S. Cl. 14/69.5; 156/196

(57) ABSTRACT

A set of generally rectangular fiber reinforced thermoplastic panels are combined by convolving selected ones thereof to form a generally longitudinal apex ridge that is then bonded to the underside of the other panel by application of heat. Preferably the convolved panels are of a planform that is smaller than the other panel, thus exposing an edge portion of the underside thereof on which an adhesive strip is deposited and covered by a removable cover. In use the adhesive strip is exposed and then adhered to the surface of a door sill or a step surface with the joined panels then providing a bridging surface allowing a wheelchair to cross the height differential.

### REFERENCE TO RELATED APPLICATIONS

This application obtains the benefit of the earlier filing date of U.S. Provisional Application No. 61/135,092 filed on Jul. 16, 2008.

### BACKGROUND OF THE INVENTION

1. Field of the Invention

The present invention relates to portable wheelchair ramps, and more particularly to lightweight ramps in which unequally convolved fiber reinforced panels are joined to each other such that the more tightly folded panel forms a varying set of support contacts with the flexing of the outer support panel as the wheelchair is translated thereover.

2. Description of the Prior Art

The accommodation and assistance for those that are handicapped has been a constant focus of all civilized societies, to a point where the current architecture of our public places invariably includes structures that facilitate the mobility of those that are confined to a wheelchair. These concerns are expressed in various local ordinances and also in our general laws, as for example in the statutory enactments of the Americans with Disabilities Act [ADA], with the result that virtually all public places are easily traversed by those on wheeled carriages. Simply, our drive for personal independenc has compelled all sorts of conveniences in public places that accommodate the handicapped.

The same regulatory compulsions, however, face a more difficult economic challenge when confronted by the interests of privacy of individual households where the cost cannot be distributed or shared. Accordingly, private residences have had little regulatory attention other than regulations that deal with the basic concerns over health and safety. The age distribution of our residential inventory and the strongly imbedded notions of individual privacy resulted in a structural mix that rarely fits wheelchairs.

Thus even if the handicapped person selects a residence that has some of the favorable aspects, e.g., all on a single floor with rolling paths from the garage to the residence, and so on, old structural habits like door sills persist that for one reason or another render wheelchair transit difficult. This, of course, then creates a demand for various ramps and the like, but the transitory nature of all human contact does not just confine the needs for wheelchair mobility to one's own residence alone. Those that are handicapped need to consider their social ventures that lead into residences of others that are not so encumbered and thus the need for light, easily transported ramps.

In the past various ramp structures were devised that in one manner or another form a bridging structure between the varying levels of the floor, exemplified by the teachings of U.S. Pat. No. 5,946,756 to Mapp; and U.S. Pat. No. 5,324,004 to Richardson. While suitable for the purposes intended, each of these prior examples entails a three dimensional structure that obtains its strength from its monococque or semi-monococque configuration which inherently renders the ramp configuration both bulky and stiff and therefore difficult to carry.

Alternatively, foldable and articulated ramp structures have been proposed, as exemplified in the teachings of U.S. Pat. No. 7,001,132 to Koretsky et al.; U.S. Pat. No. 6,698,998 to Koretsky; U.S. Pat. No. 6,343,908 to Oudsten et al.; and U.S. Pat. No. 4,864,673 to Adaway et al. Each of these references, and similar others, while again suitable for the purposes intended, describe fairly complex folding ramp structures that are deployable by unfolding a bridging structure for a wheelchair either at the entrance of a vehicle or across an obstruction.

These bulky and complex features of the prior art ramp structures are particularly inconvenient in settings where the wheelchair confined person is simply a visitor in someone else's home under circumstances where the deployment complexity and/or necessary structural accommodation present an excessive burden to the host. Simply, the imposition of these burdens are often the primary obstacle to a full social life of an invalid who, quite often, simply elects to remain at home rather than impose on others.

In all their general configurations the prior art ramp structures are necessarily bulky and therefore difficult to store and/or transport and thus their use is limited to those applications to which they are directed. A lightweight, easily carried and easily deployed ramp structure adaptable to a wide range of transit impediments is therefore extensively desired and it is one such ramp structure that is disclosed herein.

### BRIEF SUMMARY OF THE INVENTION

Accordingly, it is the general purpose and object of the present invention to provide a layered ramp structure in which convolved fiber reinforced polymeric panels are joined to an outer panel to form an intermediate bridging support for a wheeled carrier traversing the outer panel.

Other objects of the invention are to provide a lightweight ramp structure in which a larger upper panel is supported by one or more convolved lower panels dimensioned to expose an adhesive strip along the underside of the outer panel edge for releasable contact to the impeding surface across which the ramp is deployed.

Yet further and additional objects of the invention shall become apparent upon the inspection of the illustrations and text that now follow.

Briefly, these and other objects are accomplished within the present invention by providing a generally rectangular fiber reinforced polymeric outer panel of a planform width generally greater than the base of a wheelchair which is then adhesively mounted along its center line onto the several spines or ridges of two or more longitudinally convolved lower panels. Each of these lower panels is again formed of a fiber reinforced polymeric material structure dimensioned substantially smaller than the outer panel and bent by heat application to form a generally V-shaped section.

Preferably, the segments on either side of the fold in each of the lower panels are each dimensioned to a transverse dimension that is somewhat greater than the typical height of a wheelchair impediment, e.g., the height of the door step or the entryway sill, thus providing an inclined bridging surface when the impeding edge is received in the fold. The underside of the other edge portion of the outer panel that then extends beyond the other segments of the lower panels onto the impediment's upper horizontal surface is, in turn, provided with a covered adhesive strip that is then exposed and adhered to this surface once properly aligned.

In this form the wheelchair confined visitor, or the thoughtful host, are able to temporarily modify the several problematic impediments in the residence by a device that is easily removed once the visit ends. When not in use the simplicity of the impediment bridging structure and its flexible form lend themselves to easy and convenient storage either in corners behind other stored objects or within the elements of a folded wheelchair.

Those skilled in the art will appreciate that in both the panel components of the inventive bridging device the material structures used are fiber reinforced polymeric panels selected from the many known thermoplastic polymer groups which can be bent when heated to the desired fold shapes and thereafter fused together by further application of heat to the juncture between the apex of the lower panels and the outer panel to which they attach. This last heat application, in particular, consolidates the panel juncture into a fairly robust mass of fiber reinforced matter that provides structural stiffness to all the joined components, thus reinforcing the bridging segment of the lower panels while also limiting the outer surface to smooth bends on either side of the apex that expand into load induced undulations that are easily traversed.

In this manner a lightweight, inexpensive and easily carried and ramp structure is devised which can be easily deployed. These structural benefits can be easily implemented in various manners and with various polymeric materials with the necessary panel stiffness assured by the appropriated selection of the reinforcing fiber thickness, its weave and its density.

### BRIEF DESCRIPTION OF THE DRAWINGS

FIG. 1 is a perspective illustration, separated by parts, of the several elements of the inventive ramp structure arranged for heat bonding into a unitary structure;

FIG. 2 is a further perspective illustration of the inventive ramp structure in its assembled and bonded form;

FIG. 3 is a bottom view of the inventive ramp structure shown in FIG. 2;

FIG. 4 is a sectional detail illustrating the integrated fiber reinforced juncture mass resulting from the heat bonding of the several elements of the inventive ramp structure;

FIG. 5 is a diagrammatic illustration of the inventive ramp structure illustrating the flexures thereof while supporting a traversing wheelchair; and

FIG. 6 is a perspective detail of a wheelchair traversing an overlaid pair of inventive ramp structures bridging over a doorsill.

### DESCRIPTION OF THE PREFERRED EMBODIMENT

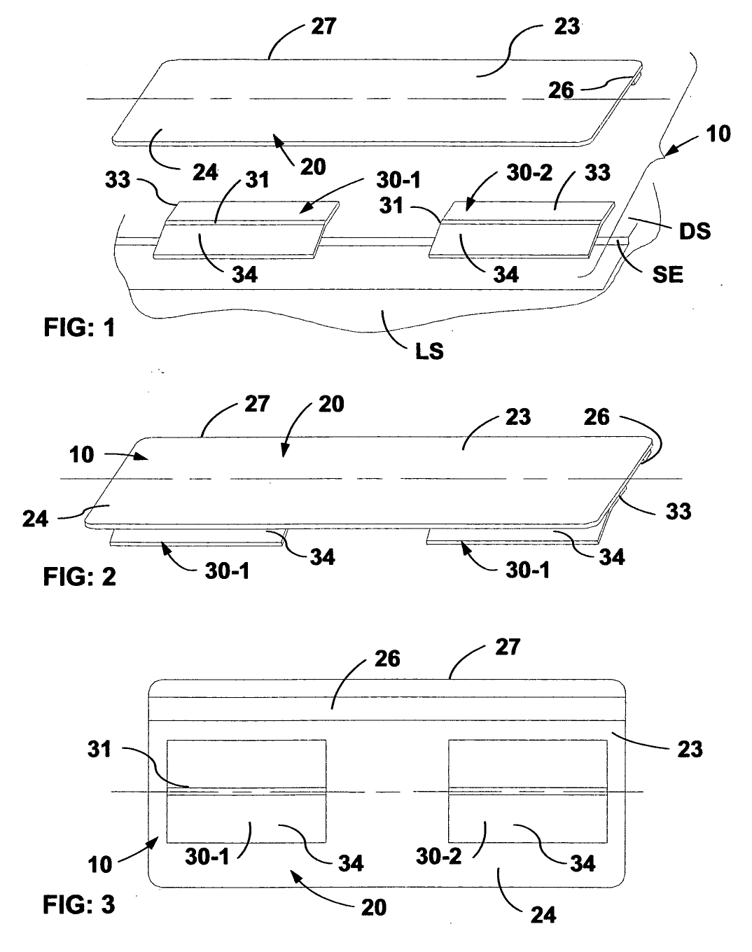

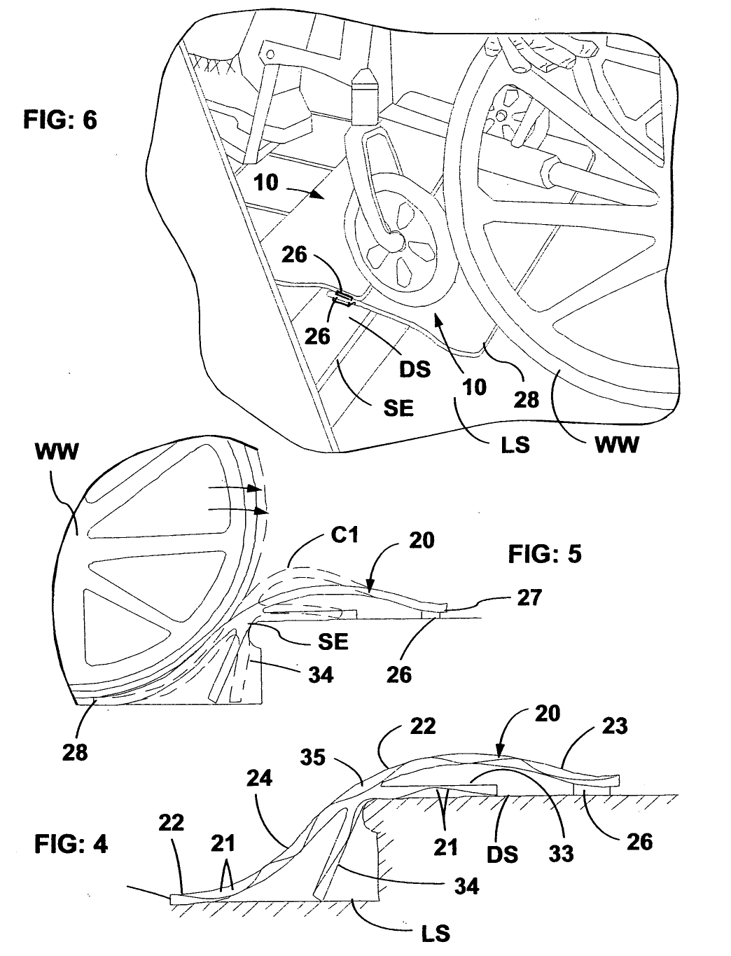

As shown in FIGS. 1 through 6, the inventive ramp structure generally designated by the numeral 10 comprises and outer panel 20 of a generally flexible rectangular planform having a longitudinal dimension conformed for receipt within a doorway, which in accordance with the current customs and practices in the United States is somewhat less than 32 inches. The other planform dimension of panel 20, in turn, is selected to fully bridge over a typical doorstep, or door sill, which according to conventional practices and the teachings hereinbelow is best effected within a dimensional range of 15 to 27 inches. Preferably this outer panel 20 is formed of a fiber reinforced thermoplastic polymer structure with a glass fiber woven mat 21 of a weave density of 1.3 to 2.2 g/cm3 and fiber thickness of 0.015 to 0.025 inches (0.038 to 0.063 cm) imbedded in a layer 22 of a thermoplastic polymer deposited to a thickness of 0.020 to 0.080 inches (0.05 to 0.20 cm).

A pair of lower panels 30-1 and 30-2, each of a planform that is less than one half of the planform dimensions of panel 20 but formed of a material structure generally like the above described panel, are each convolved by heat application to form a central apex or ridge 31 that is thereafter bonded by heat application once more in spaced alignment to the underside of the outer panel 20 along an axis generally bisecting its planform. By virtue of this heat bonding of the ridges 31 of each of the lower panels 30-1 and 30-2 to the underside of panel 20 a consolidated sectional mass is developed, shown as a sectional mass 35, which both acts to stiffen the adjacent portions 23 and 24 of panel 20 while also fixing the relative alignment of the portions 33 and 34 of each of the lower panels to project in a V shape therefrom.

A releasably covered adhesive strip 26 mounted on the underside of the outer panel 20, along one longitudinal edge 27 thereof, is then useful to adhere the panel to the door sill or doorstep surface DS once the sill or step edge SE is received within the inner convolution of the ridges 31 and when thus affixed the opposite portion 34 then forms a bridging ramp from the sill edges SE to the lower surface LS in front of the sill. In this manner a stiffening reinforcement of panel 20 is obtained as the wheelchair WC is rolled thereover and thus transitioned across the impediment of the sill.

By particular reference to FIGS. 5 and 6 it will be noted that the translation of a wheelchair wheel WW onto the opposite, unadhered edge 28 of panel 20 resting on the lower surface LS flexes the panel to a curve C1 that increases its angle relative the sill edge SE, thus obtaining further structural support from the lower panel segment 34 but once the wheel WW traverses across the sill edge SE the various resulting panel flexures then restore the original alignment. In each instance, however, the result obtained is in the form of fairly smooth undulations easily accommodated by the invalid person.

Those skilled in the art will appreciate that the foregoing ramp structure utilizes to advantage polymers and glass that are currently part of our recycling stream and is thus essentially unobtrusive. Moreover, the use of one common panel material structure throughout simplifies the fabrication process of this assisting device that is easily carried, mounted and thereafter removed.

By further reference to FIG. 6 it will be appreciated that the foregoing inventive ramp 10 may be mounted in an overlaid adhesive alignment as a paired set to bridge across an impediment characterized by height discontinuities on both sides, e.g., a doorsill, a mounting convenience that is wholly not obtainable in other structures. Thus the invention obtains not only the advantages of a lightweight structure but also the foregoing combination advantage that addresses most of the impediments faced by a wheelchair borne invalid.

Obviously, many modifications and variations can be effected without departing from the spirit of the invention instantly disclosed. It is therefore intended that the scope of the invention be determined by the claims appended hereto.

1. A portable ramp structure useful in bridging across stepped elevation changes in order to accommodate the translation of a wheeled structure thereacross, comprising:
a first substantially rectangular panel formed of a fiber reinforced thermoplastic material and dimensioned to extend beyond the wheel separation span of said wheeled structure:
a second substantially rectangular panel of a planform generally smaller than said first panel and formed of a fiber reinforced thermoplastic material structure, said second panel being convolved longitudinally to form a longitudinal apex thermoplastically bonded to one side of said first panel;
an adhesive strip formed longitudinally on said one side of said first panel proximate one edge thereof; and
a releasable covering strip positioned on the exterior of said adhesive strip.

2. A ramp structure according to claim 1, wherein:
said elevation changes include a door sill; and
the separation between longitudinal apex and a longitudinal edge of said second panel is greater than the elevation of said door sill.

3. A ramp structure according to claim 2, wherein:
said first panel is of a thickness of 0.020 to 0.080 inches.

4. A ramp structure according to claim 3, wherein:
said first panel includes a glass fiber mat of a weave density of 1.3 to 2.2 grams per cubic centimeter.

5. A flexible ramp structure useful for bridging across surface discontinuities and elevation changes in a floor surface to accommodate the translation of a wheelchair thereover, comprising:
a first substantially rectangular fiber reinforced thermoplastic material panel of a longitudinal dimension greater than the wheel separation span of said wheelchair;
a plurality of second substantially rectangular fiber reinforced thermoplastic material structure panels each of a planform smaller than said first panel, each said second panel being convolved to form a longitudinal apex thermoplastically bonded to one side of said first panel; and
an adhesive strip formed on said one side of said first panel adjacent one longitudinal edge thereof.

6. A flexible ramp structure according to claim 5, further comprising:
a releasable covering positioned on the exterior of said adhesive strip.

7. A flexible ramp structure according to claim 6, wherein:
said elevation changes include a door sill; and
the separation between longitudinal apex and a longitudinal edge of said second panel is greater than the elevation of said door sill.

8. A ramp structure according to claim 7, wherein:
said first panel is of a thickness of 0.05 to 0.2 centimeters.

9. A ramp structure according to claim 8, wherein:
said first panel includes a glass fiber mat of a weave density of 1.3 to 2.2 grams per cubic centimeter.

10. A method of fabricating a lightweight flexible ramp structure for selective bridging across floor surface elevation discontinuities in the rolling path of a wheelchair, comprising the steps of:
forming a generally rectangular first and second panel from a thermoplastic polymeric material reinforced by a glass fiber mat;
convolving said second panel to form a longitudinal apex ridge extending laterally thereacross; and
adhering by application of heat said apex ridge of said second panel to one surface of said first panel.

11. A method according to claim 10, further comprising the step of:
depositing an adhesive strip on said one surface of said first panel in an alignment adjacent a longitudinal edge thereof.

12. A method according to claim 11, wherein:
said first panel is of a planform larger than the planform of said second panel.

13. A method according to claim 12, wherein:
said elevation discontinuities include a door sill; and
the separation between said longitudinal apex ridge and a longitudinal edge of said second panel is greater than the elevation of said door sill.

14. A method according to claim 13, wherein:
said first and second panel each include a glass fiber mat of a weave density of 1.3 to 2.2 grams per cubic centimeter.

15. A method according to claim 14, wherein:
said first and second panels are each of a thickness of 0.05 to 0.2 centimeters.

16. A method according to claim 15, further comprising the step of:
covering with a releasable strip the exterior of said adhesive strip.
